(19) United States
(12) Patent Application Publication
(10) Pub. No.: US 2002/0043018 A1
(43) Pub. Date: Apr. 18, 2002

(54) Rock simulating pest trap

(76) Inventor: Lyle Townsend, Kirkland, WA (US)

Correspondence Address: Dean A. Craine, P.S., Suite 140, 400-112th Ave. N.E., Bellevue, WA, 98004-5542, US

(21) Appl. No.: 09/929,779

(22) Filed: Aug. 14, 2001

Related U.S. Application Data
(60) Provisional application No. 60/241,244, filed on Oct. 18, 2000.

(51) Int. Cl. A01M 1/20; A01M 25/00

(52) U.S. Cl. 43/131

(57) ABSTRACT

A tamper-resistant pest trap that has an outer housing that simulates a rock typically found in a garden or landscape area around a residence or building. The outer housing is a hollow structure with a removable holding tray located therein. Formed on the sides of the outer housing are two, first and second side tunnels that bend and curve inward from the sides of the outer housing towards the center of the outer housing. Formed on the end of each side tunnel is at least one pest opening which enables a pest to enter the outer housing's cavity. In one embodiment, a large opening is formed on the bottom surface of the outer housing into which a holding tray may be securely placed. In another embodiment, the outer housing includes a lid member pivotally attached to a bottom member with the holding tray attached to a bottom member with the holding tray attached to the bottom member. Disposed inside the holding trap is a suitable poison or a trap. Optional stake and hold-down chain is attached to the outer housing is also provided to prevent movement of the trap.

This is a utility patent application based on a provisional patent application (Ser. No. 60/241,244) filed on Oct. 18, 2000.

### BACKGROUND OF THE INVENTION

1. Field of the Invention

This invention pertains to pest traps, and, in particular, to pest traps designed to be used in outdoor, visible areas.

2. Description of the Related Art

Most home and business owners would prefer to place pest traps, when needed, outside their residence or business. Because deadly diseases and filthy conditions are often associated with insects and rodents, the placement of traps inside residences and businesses where they may be in plain view of guests or visitors is undesirable.

In order to use a pest trap outdoors, a protective outer housing is used which houses the poisoned bait or body-piercing trap. Such traps are disclosed in U.S. Pat. Nos. 4,541,198, 4,550,525, 4,611,426, 4,730,412, 5,040,327, 5,448,852, and 6,082,042.

One drawback of such traps is that the outer housings are relatively large structures that are visible at a distance. Because of the negative connotation associated with insect and rodent traps, most homeowners find the visibility of such traps objectionable. Although the traps may be placed behind other objects or covered with dirt to hide them, this is undesirable because it prevents the trapper from easily checking or retrieving the traps.

What is needed is a tamper-resistant, inconspicuous outdoor pest trap that is effectively disguised as a large object typically found in a garden, such as a rock.

### SUMMARY OF THE INVENTION

It is an object of the present invention to provide a pest trap designed for outdoor use.

It is another object of the present invention to provide such a pest trap that is tamper-resistant by isolating the poisoned bait or animal trap inside an outer housing to prevent unintentional targets, such as children, pets, and other small animals, from contacting the bait or trap.

It is a further object of the present invention to provide a pest trap that is disguised as a large rock, so that it may be placed anywhere in a yard or garden so that customers or neighbors are not privy to the fact that a pest problem may exist.

These and other objects of the invention which will become apparent are met by a tamper-resistant pest trap that has an outer housing that simulates a rock typically found in the garden or landscape areas around a residence or building. The outer housing is a hollow structure with a large cavity formed therein in which a holding tray may be placed. Formed on the sides of the outer housing are small pest openings that enable insects or small rodents to enter the large cavity during use. In the preferred embodiment, two first and second side tunnels are formed on the sides of the outer housing which bend and terminate inside the outer housing to form a hidden pest opening thereby preventing visibility of the pest openings when standing adjacent to the outer housing. The outer housing has a flat bottom surface so that the pest trap may be set up on the soil. In one embodiment, a large opening is formed in the bottom surface which communicates with the large cavity formed in the outer housing so that the holding tray may be selectively inserted into the large cavity. During assembly, suitable bait or a trap is placed into the holding tray before it is inserted into the large opening and secured in position inside the outer housing. When pests enter the outer housing and ingest the poison or activate the trap, they are killed inside the outer housing. In another embodiment, the outer housing comprises a lid member pivotally attached along one edge of a flat bottom with the holding tray affixed to the top surface of the bottom member.

In both embodiments, an optional stake and hold-down chain may be provided which are used to secure the outer housing on the ground to prevent its movement.

### BRIEF DESCRIPTION OF THE DRAWINGS

FIG. 1 is a perspective view of the pest trap disclosed herein, appearing to be a real rock placed in a yard.

FIG. 2 is a front elevational view of the invention.

FIG. 3 is a rear elevation view of the invention.

FIG. 4 is a right side elevation view of the invention.

FIG. 5 is a left side elevation view of the invention.

FIG. 6 is a bottom plan view of the invention.

FIG. 7 is a perspective view of the bait/trap holding tray that may enclose bait or a spring-loaded trap.

FIG. 8 is a side elevational view of the invention being held in place by the optional stake and chain.

FIG. 9 is a front elevation view of a second embodiment of the invention comprising a pivoting lid member attached to a bottom member.

FIG. 10 is a side elevation view of the second embodiment shown in FIG. 9 showing the lid member revised to allow the user access to the cavity.

FIG. 11 is a perspective view of the second embodiment of the invention in which the pest opening comprises a plurality of small openings for insects.

### DESCRIPTION OF THE PREFERRED EMBODIMENT(S)

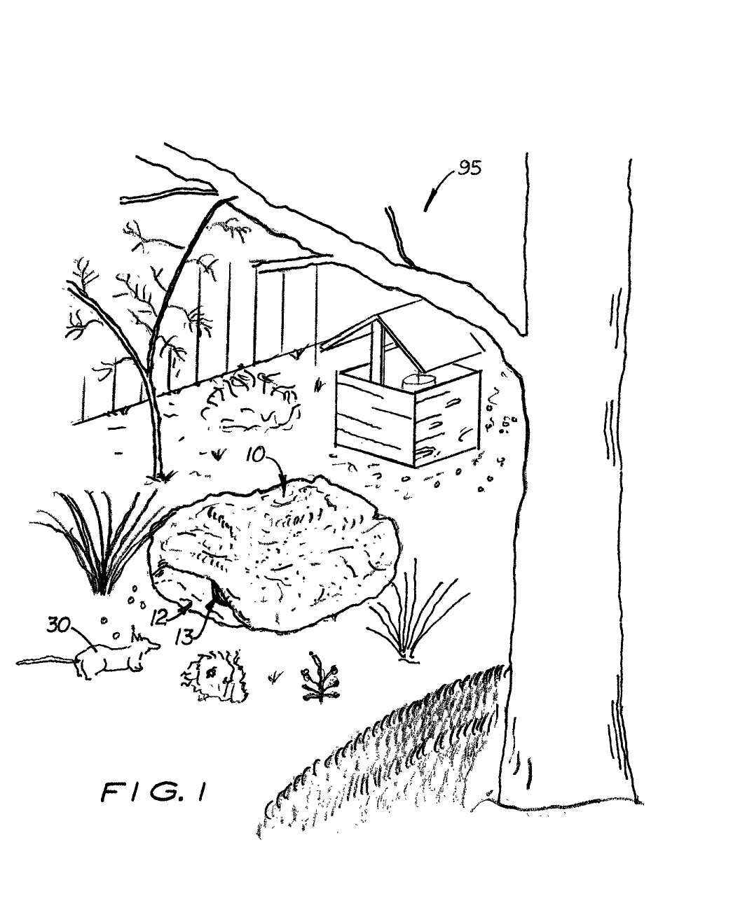

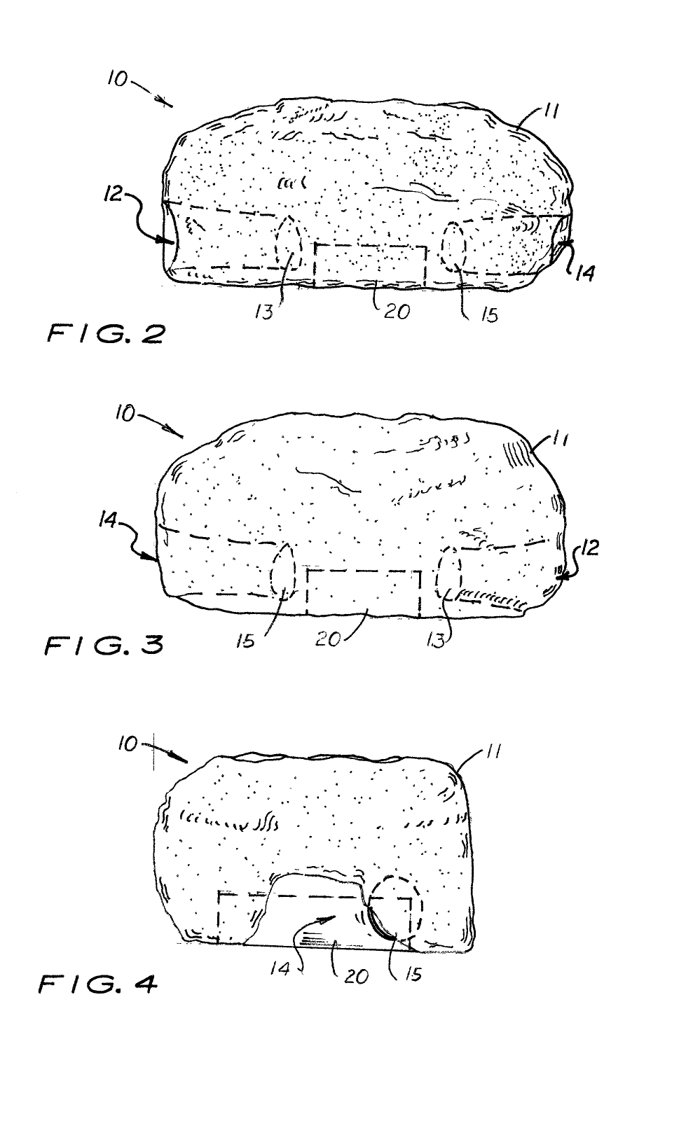

Referring to FIG. 1-5, there is shown and described a pest trap 10 designed to simulate a rock in a garden or landscape area 95. The pest trap 10 includes a hollow outer housing 11 with a large cavity 45 formed therein. Formed on the outer housing 11 are side tunnels 12, 14 that lead to the large cavity 45. Pest openings 13, 15 are formed on the sides of the outer housing 11 adjacent to the terminating inside surface of the side tunnels 12, 14 through which a rodent 30 or insects (not shown) may enter and/or exit the outer housing 11.

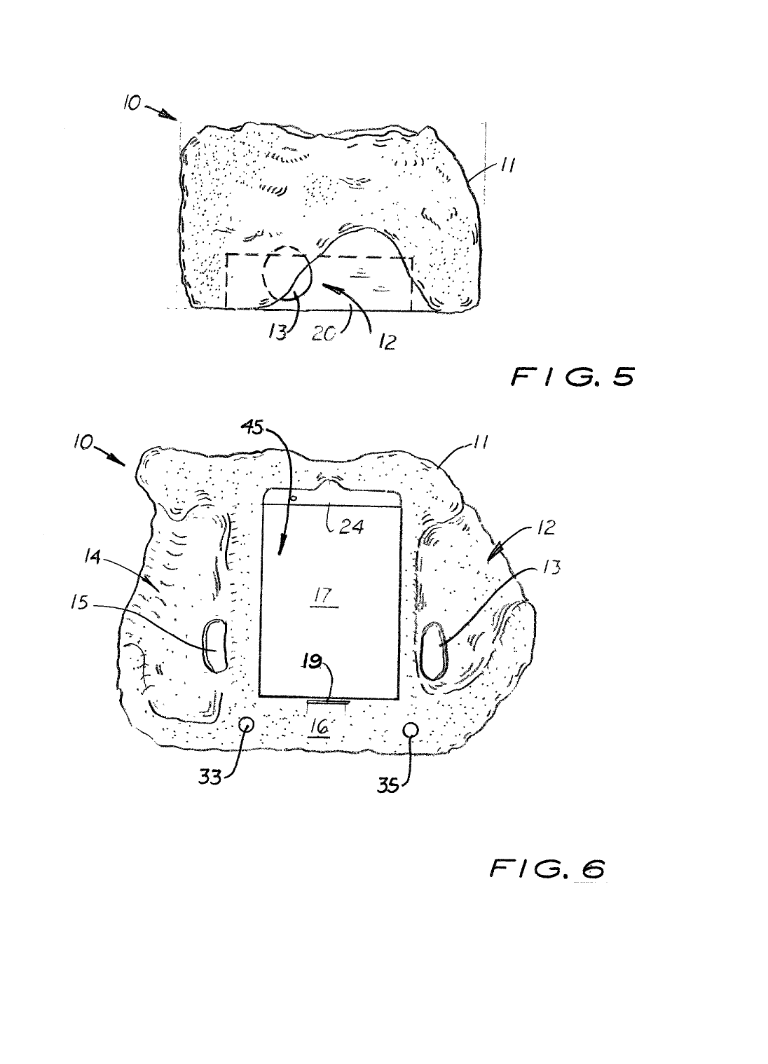

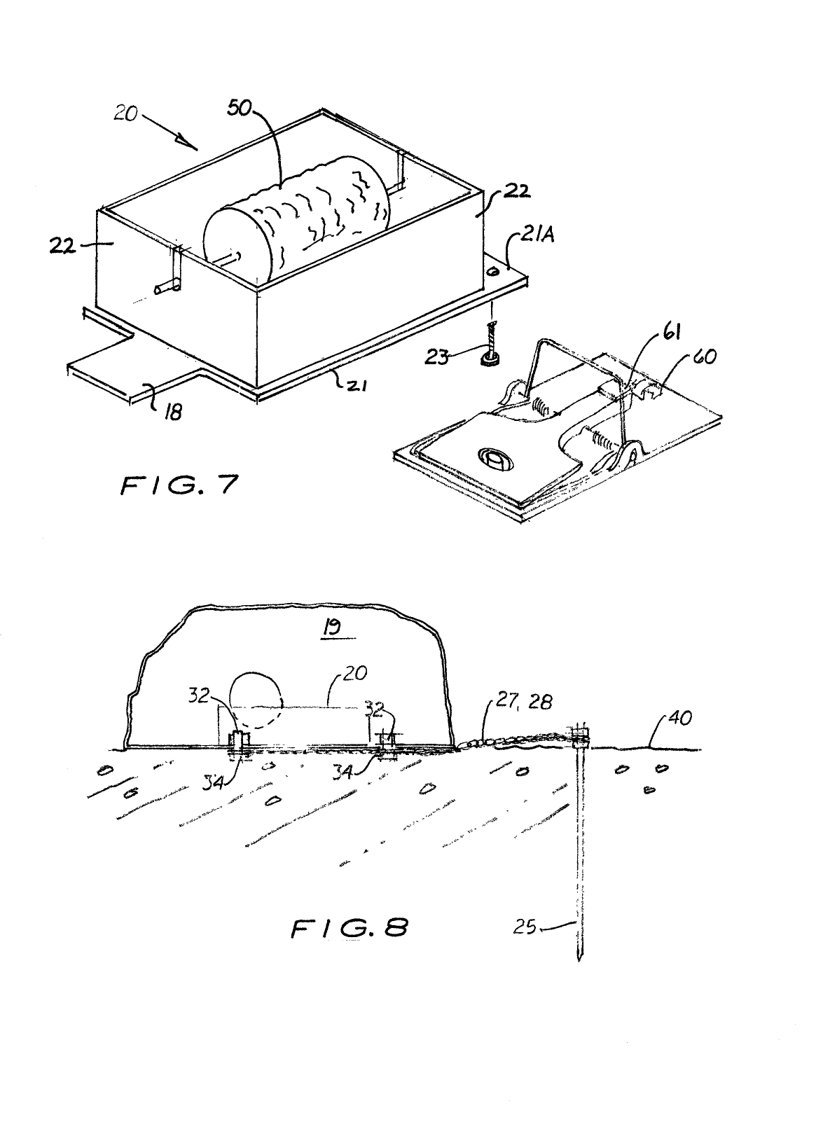

As shown in FIG. 6, the bottom surface 16 of the outer housing 11 is flat so that the outer housing 11 may be positioned on flat soil. Formed centrally on the bottom surface 16 is an opening 17 which provides the user access to the cavity 45. During assembly a holding tray 20 is inserted into the opening 17 and extending into the large cavity 45. An attachment means is provided for selectively attaching the holding tray 20 inside the opening 17.

In the preferred embodiment, the outer housing 11 is made of ⅛ inch cross-linked polyurethane and is gray in color with black flakes to simulate a “one” to “three man” size granite rock. The outer housing 11 measures approximately 15 inches in length, 11 inches in width, and 6 inches in height, and weight approximately 2 lbs. In the preferred embodiment, the two side tunnels 12, 14 are approximately 2½ inches in width and height and three to six inches in length. The interior surfaces of the side tunnels 12, 14 are ragged so that the side tunnels 12, 14 appear as natural crevices or openings in a large rock. Each side tunnel 12, 14 is slightly curved so that the openings 13, 15 are invisible when the rock is viewed from the side.

As mentioned above, the pest openings 13, 15 are designed to allow a rodent 30 such as a mouse or rat enter and exist the outer housing 11. In a second embodiment, shown in FIG. 11, the pest openings comprise a plurality of small openings 48 designed to allow insects 31, such as ants or termites, to enter the outer housing 11. Larger insects or animals are unable to enter the outer housing 11.

The holding tray 20 is designed to completely close off the opening 17. In the preferred embodiment, the holding tray 20 is rectangular with a flat bottom surface with four side walls 22 that extend upward therefrom. A longitudinally aligned rearward section 21A is formed on one end and a tab 24 is formed on the opposite end of the bottom surface 21. Formed inside the holding tray 20 is an open cavity 45 in which suitable poison 55 or trap 60 may be placed In the preferred embodiment, attachment means are used to securely attach the holding tray 20 over the opening 17. In the referred embodiment, the attachment means includes is a slot 19 formed on one side of the opening 17 which receives the tab 24 on the holding tray 20. During assembly, the holding tray 20 is placed into the opening so that the tab 24 engages the slot 19. A suitable connector 23 is used to selectively affix the rearward extending section 21A of the bottom surface 21 of the holding tray 20 to the bottom surface 16 of the outer housing 11.

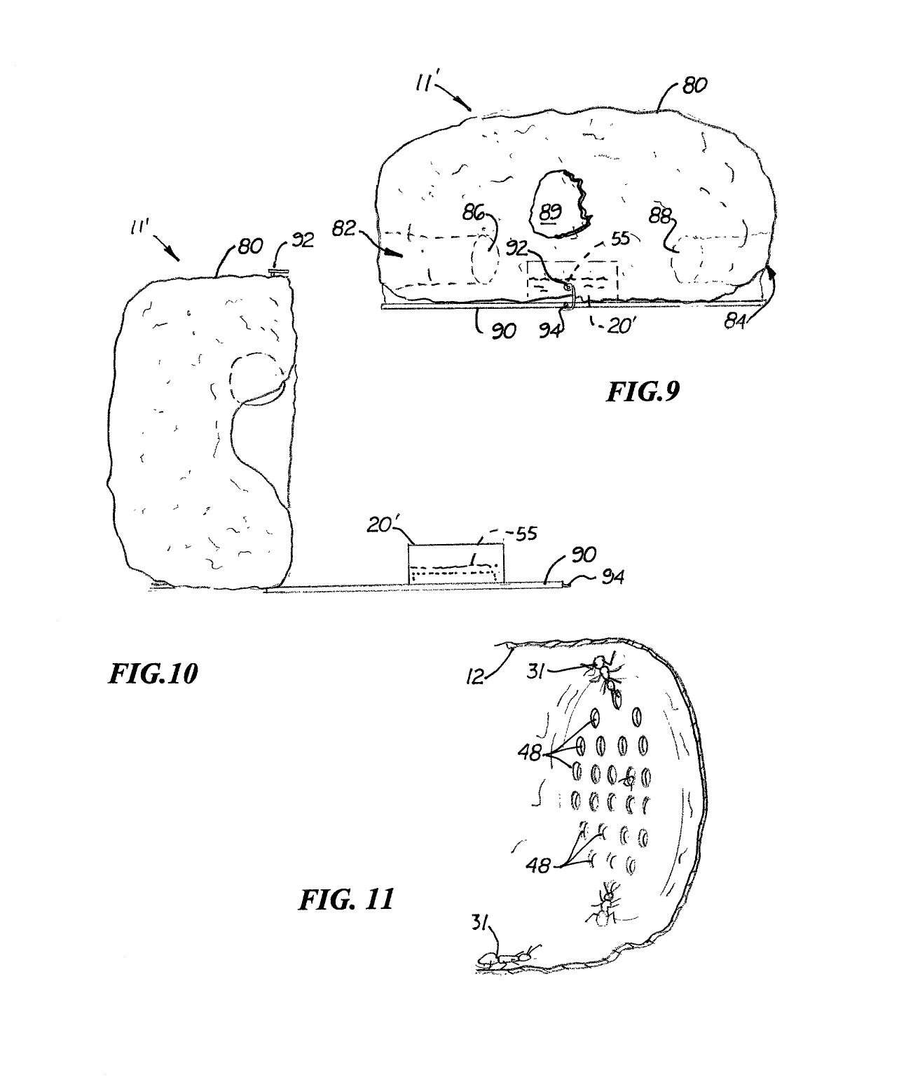

In another embodiment shown in FIGS. 9 and 10, the outer housing (denoted 11′) comprises a lid member 80 pivotally attached along one edge to a flat bottom member 90. The lid member 80 has an outer surface with suitable color and texture to simulate a large rock. Like outer housing 11, tunnels 82, 84 are formed on the outer housing 11′ which bend and extend interiorly and terminate at two opposite side openings 86, 88 so that a pest may enter the cavity 89 formed inside the outer housing 11′ when the lid member 80 is closed over the bottom member 90. The holding tray (denoted as 20′) is fixed to the bottom member 90 so that the user gains access to the poison 55 or trap by opening the lid member 80. An optional latch 92 and pin 94 may be attached to the lid member 80 and bottom member 90 to lock them together during use.

As stated above, a suitable poison 55 or trap 60 is placed inside the open cavity 45 on the holding tray 20, 20′. Once the poison 55 or trap 60 is positioned and reset inside the holding tray 20, 20′, the holding tray 20, 20′ is then disposed inside the cavity 45, 89 or the lid member 80 is closed over the bottom member 90 so that a pest which enters the cavity 45, 89, respectively, has access to the poison 55 or trap 60.

When the desired pests are insects 31, the small side opening 13, 15 can be replaced with a plurality of small insect-size openings, 48, respectively, formed at the end surfaces of the two tunnels 12, 14, as shown in FIG. 11. An insecticide may be used in place of a rodentcide or trap.

The outer housing 11 may be held in place on the ground 40 by an optional stake 25 that tautly tethers the outer housing 11 to the ground 40 with one or two short chains 27, 28 as shown in FIG. 8. Bolts and nuts 32, 34 are inserted through holes 33, 35, respectively, formed on the bottom surface 16 of the outer housing 11. In the preferred embodiment, the stake 26 is a round rod approximately ¼ inch in diameter and 16 inches in length which maybe easily driven into the ground. The chains 27, 28 are approximately 8 inches in length.

During use, pests are attracted to the smell of the poison 55 or bait 61 located in the holding tray 20. The pest enters either one of the two side openings 13, 15, or 48 through the tunnels 12, 14, or 84, respectively. Once the pest enters the outer housing 11, 11′ it has access to the poison 55 or bait 61 in the holding tray 20, 20′. The pest eats the poison 55 or eats the bait 61 causing activation of the trap 60 and dies relatively quickly inside the outer housing 11, 11′. The operator of the pest trap 10 then removes the holding tray 20, 20′ to gain access to the cavity 45, 89 to remove the dead pest from the outer housing 11, 11′, add more poison 55 or bait 61 or re-set the trap 60 in the holding tray 20, 20′.

In compliance with the statute, the invention described herein has been described in language more or less specific as to structural features. It should be understood, however, that the invention is not limited to the specific features shown, since the means and construction shown, comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A pest trap, comprising:
a. a hollow, outer housing with a flat bottom surface, said outer housing having an outer shape and color to simulate a rock said outer housing an inner cavity, said outer housing having a partially concealed first side tunnel;
b. at least one pest opening formed on said first side tunnel to access said inner cavity;
c. a holding tray disposed inside said inner cavity; and,
d. a pest terminating means located inside said holding tray.

2. The pest trap as recited in claim 1, further including an opening formed on said bottom surface to enable said holding tray to be placed inside said inner cavity.

3. The pest trap as recited in claim 2, including means to attach said holding tray over said opening formed on said bottom surface.

4. The pest trap as recited in claim 1, wherein said pest opening on said first side tunnel is at least one inch in diameter.

5. The pest trap as recited in claim 1, wherein said pest opening is at least ⅛ inch in diameter.

6. The pest trap as recited in claim 1, wherein said pest terminating means is a chemical rodentcide.

7. The pest trap as recited in claim 1, further including a ground holding means used to hold said outer housing to the ground.

8. The pest trap as recited in claim 7, wherein said ground holding means is a ground-piercing stake.

9. The pest trap as recited in claim 1, wherein said outer housing has an outer appearance that simulates a granite rock.

10. The pest trap as recited in claim 1, further including a second concealed side tunnel formed on said outer housing opposite said first concealed side tunnel.

11. The pest trap as recited in claim 10 further including a pest opening formed on said second side tunnel enabling a pest to enter said inner cavity.

12. The pest trap as recited in claim 11, wherein said pest opening on said second side tunnel is approximately one inch in diameter.

13. The pest trap as recited in claim 9, wherein said pest opening is approximately ⅛ inch in diameter.

14. The pest trap as recited in claim 1, wherein said outer housing comprises a rock simulating lid member pivotally attached along one edge to a flat bottom member.

15. The pest trap as recited in claim 12, wherein said pest terminating means is a chemical rodentcide.

16. The pest trap as recited in claim 12, wherein said pest terminating means is a spring-loaded trap.

17. The pest trap as recited in claim 13, wherein said pest terminating means is an insecticide.

18. The pest trap as recited in claim 14, further including a ground holding means used to hold said outer housing to the ground.

19. The pest trap as recited in claim 14, wherein said holding tray is attached to said bottom member.

20. The pest trap as recited in claim 14, further including a second side tunnel formed on said outer housing opposite said first side tunnel with a pest opening formed therein to allow a pest to enter said inner cavity.
